(19) United States
(12) Patent Application Publication
(10) Pub. No.: US 2010/0026512 A1
(43) Pub. Date: Feb. 4, 2010

(54) REMOTE CONTROLLER OF ELECTRONIC APPARATUS

(76) Inventor: Chen-Leh Wang, Taipei (TW)

Correspondence Address: NORTH AMERICA INTELLECTUAL PROPERTY CORPORATION, P.O. BOX 506, MERRIFIELD, VA, 22116, US

(21) Appl. No.: 12/184,253

(22) Filed: Aug. 1, 2008

(51) Int. Cl. G05B 19/02

(52) U.S. Cl. 340/825.22

(57) ABSTRACT

The present invention discloses a remote controller of an electronic apparatus. The remote controller includes a memory interface for communicating with a memory device; a controlling circuit coupled to the memory interface for generating a first control signal; and a first communication interface coupled to the controlling circuit for communicating with the electronic apparatus to transfer data between the memory device and the electronic apparatus according to the first control signal.

### BACKGROUND

The present invention relates to a remote controller and method thereof, and more particularly to a remote controller that is able to communicate with an electronic apparatus, and a communicating method thereof.

Nowadays, most electronic devices have their own wireless controllers. For example, televisions have television remote controllers, radios have radio remote controllers, and even some refrigerators have their own controllers. The above-mentioned remote controllers utilize an infrared (IR) signal as the transmitting medium of the controlling signal. In addition, even though infrared technology has been around for a long time, the transmission rate of these infrared rays still remains low. Therefore, intrinsically, a comparatively larger amount of data may not be transmitted via an infrared (IR) signal quickly and effectively. On the other hand, utilizing a controller to control an electronic device has always been in a single direction, meaning that data or a response signal generated by the electronic device cannot be received by the controller. Therefore, communication between a controller and corresponding electronic device is one of the main issues in current communications technology.

### SUMMARY OF THE INVENTION

Therefore, one of the objectives of the present invention is to provide a remote controller that is able to communicate with an electronic apparatus, and a communicating method thereof.

According to an embodiment of the present invention, a remote controller of an electronic apparatus is provided. The remote controller comprises a memory interface, a controlling circuit, and a first communication interface. The memory interface is utilized for communicating with a memory device. The controlling circuit is coupled to the memory interface for generating a first control signal. The first communication interface is coupled to the controlling circuit for communicating with the electronic apparatus to transfer data between the memory device and the electronic apparatus according to the first control signal.

According to another embodiment of the present invention, a remote control method of an electronic apparatus is provided. The remote control method comprises the steps of: communicating with the electronic apparatus to transfer a first command associated with access of a memory device to the electronic apparatus; receiving a second command outputted from the electronic apparatus in response to the first command; and communicating with the electronic apparatus to transfer data between the memory device and the electronic apparatus according to the second command.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a communication between a remote controller and an electronic apparatus.

FIG. 2 is a diagram illustrating a remote control method of the electronic apparatus as shown in FIG. 1.

FIG. 3 is a diagram illustrating the second embodiment of a remote controller according to the present invention.

### DETAILED DESCRIPTION

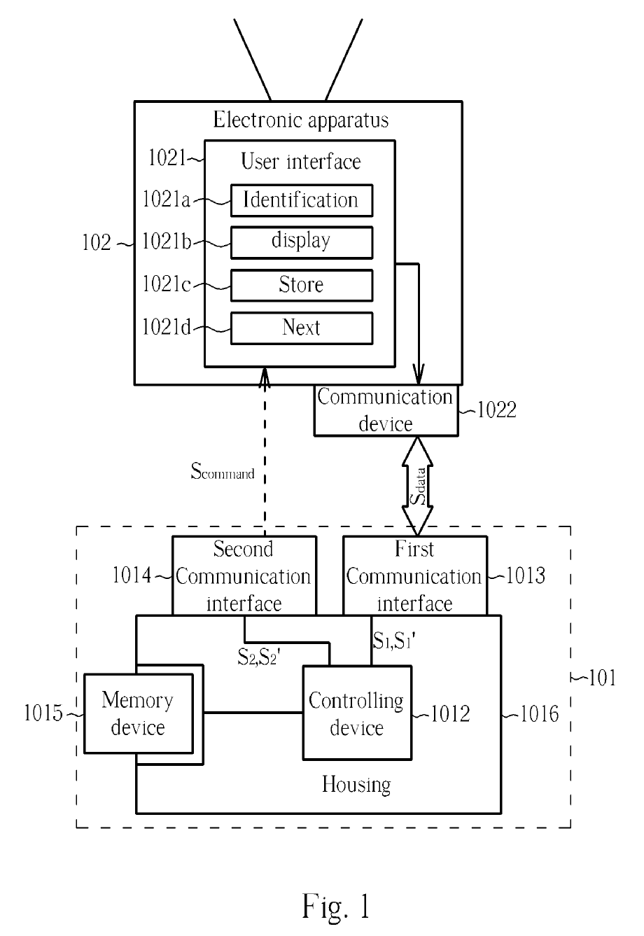

Please refer to FIG. 1. FIG. 1 is a diagram illustrating a communication between a remote controller 101 and an electronic apparatus 102. The remote controller 101 comprises a memory interface 1011, a controlling circuit 1012, a first communication interface 1013, a second communication interface 1014, and a housing 1016. The housing 1016 is utilized for holding the memory interface 1011, the controlling circuit 1012, the first communication interface 1013, and the second communication interface 1014 as shown in FIG. 1. The memory interface 1011 is utilized for communicating with a memory device 1015. The controlling circuit 1012 is coupled to the memory interface 1011 for generating a first control signal S₁. The first communication interface 1013 is coupled to the controlling circuit 1012 for communicating with the electronic apparatus 102 to transfer data S_{data} between the memory device 1015 and the electronic apparatus 102 according to the first control signal S₁. The controlling circuit 1012 further generates a second control signal S₂, and the remote controller 101 further comprises a second communication interface 1014 coupled to the controlling circuit 1012 for communicating with the electronic apparatus 102 to transfer command signal S_{command} associated with access of the memory device 1015 from the controlling circuit 1012 to the electronic apparatus 102 according to the second control signal S₂. Furthermore, the electronic apparatus 102 comprises a user interface 1021 and a communication device 1022. The communication device 1022 corresponds to the first communication interface 1013 for communicating data between the electronic apparatus 102 and the remote controller 101. According to an embodiment of the present invention, the first communication interface 1013 is a Bluetooth interface, the second communication interface 1014 is an infrared (IR) interface, and the memory interface 1011 is a card reader for detachably coupling the memory device 1015; this is not, however, meant to be a limitation of the present invention.

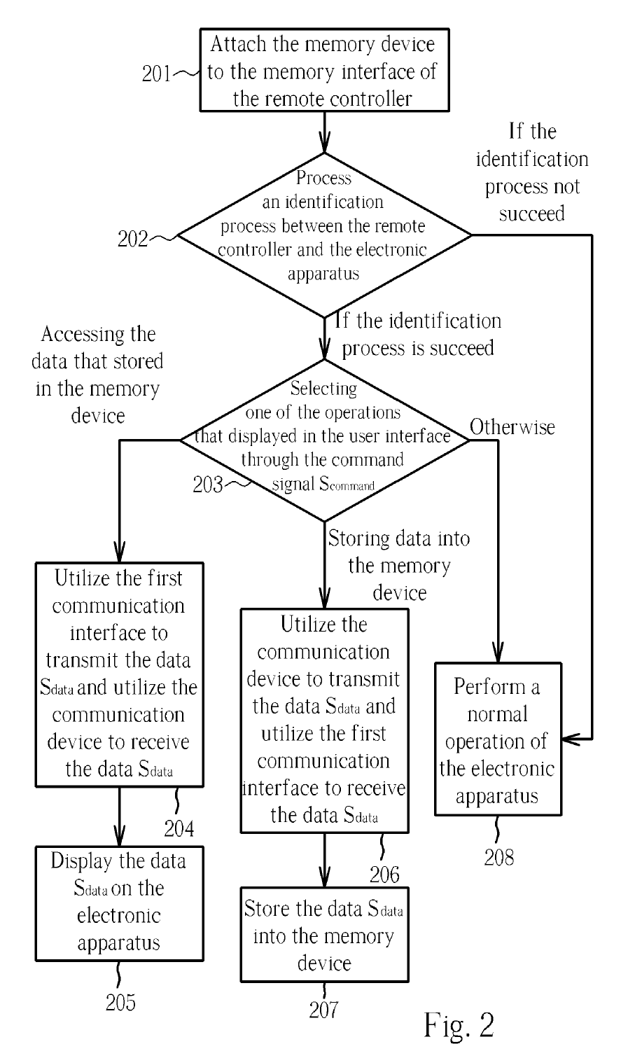

Please refer to FIG. 2. FIG. 2 is a diagram illustrating a remote control method of the electronic apparatus 102 according to the present invention. Provided that substantially the same result is achieved, the steps of the flowchart shown in FIG. 2 need not be in the exact order shown and need not be contiguous; that is, other steps can be intermediate. The remote control method comprises the following steps:
Step 201: Attach the memory device 1015 to the memory interface 1011 of the remote controller 101;
Step 202: Process an identification process between the remote controller 101 and the electronic apparatus 102. If the identification process is successful, go to step 203; otherwise, go to step 208;
Step 203: Select one of the operations that are displayed in the user interface 1021 through the command signal S_{command}. If the selected operation involves accessing data that is stored in the memory device 1015, go to step 204; if the selected operation involves storing data into memory device 1015, go to step 206; otherwise, go to step 208;
Step 204: Utilize the first communication interface 1013 to transmit the data S_{data} and utilize the communication device 1022 to receive the data S_{data};
Step 205: Display the data S_{data} on the electronic apparatus 102;
Step 206: Utilize the communication device 1022 to transmit the data S_{data} and utilize the first communication interface 1013 to receive the data S_{data};
Step 207: Store the data S_{data} into memory device 1015;
Step 208: Perform a normal operation of the electronic apparatus 102.

In step 201, when the memory device 1015 is coupled to the memory interface 1011, the controlling circuit 1012 controls the memory interface 1011 to activate memory device 1015. Then, if a user needs to read data from the memory device 1015 (for example, to play media), the user may press a button (not shown) on the remote controller 101 to instruct the controlling circuit 1012 to generate the second control signal S₂ to the second communication interface 1014. The second communication interface 1014 then transmits the command signal S_{command}, which corresponds to the second control signal S₂, to the electronic apparatus 102 for activating the user interface 1021. In the user interface 1021, there are a plurality of options as shown in FIG. 1, and one of the options is the display option 1021b. The user can select the display option 1021b through the command signal S_{command}. Please note that the present invention is not limited to utilizing the command signal S_{command} for activating the user interface 1021 and selecting options in the user interface 1021, and those skilled in this art already know that the first communication interface 1013 of the remote controller 101 can also be utilized for performing the same operation.

Before the data in the memory device 1015 is transmitted to the electronic apparatus 102, an identification process between the remote controller 101 and the electronic apparatus 102 must be accomplished (step 202). According to the embodiment of the present invention, the user needs to select an identification option 1021a in the user interface 1021 to perform the identification process by controlling the command signal S_{command}. This is not, however, meant to be a limitation of the present invention; for example, the identification process can also be performed automatically. If the identification process is successful, according to the embodiment of the present invention, the controlling circuit 1012 generates the first control signal S₁, which signals the first communication interface 1013 to transmit the data S_{data} from the memory device 1015 to the communication device 1022 (step 204). Accordingly, the electronic apparatus 102 can display the data S_{data}. Please note that, according to the embodiment of the present invention, the first communication interface 1013 is a Bluetooth interface, the second communication interface 1014 is an infrared (IR) interface, the communication device 1022 is also a Bluetooth interface, the first control signal S₁ is an IR control code, and the second control signal S₂ is a Bluetooth control code. This is not intended to be a limitation of the present invention, however: any other communication device that is capable of transmitting at a large data transfer rate can be the first communication interface 1013, and any other communication device having a data transfer rate that is slower than the larger data transfer rate can be the second communication interface 1014.

Similarly, if a user needs to store data from the electronic apparatus 102 into memory device 1015, the user may press a button (not shown) on the remote controller 101 to instruct controlling circuit 1012 to generate a second control signal S₂′ to the second communication interface 1014. The second communication interface 1014 then transmits the command signal S_{command,} which now corresponds to the second control signal S₂′, to the electronic apparatus 102 for activating the user interface 1021. Similarly, one of the options is a store option 1021c as shown in FIG. 1. Then, the user can select the store option 1021c through the command signal S_{command}.

Similarly, before the data from the electronic apparatus 102 can be stored into the memory device 1015, an identification process between the remote controller 101 and the electronic apparatus 102 must be accomplished (step 202). According to the embodiment of the present invention, the user needs to select the identification option 1021a in the user interface 1021 to perform the identification process by controlling the command signal S_{command}. However, this is not a limitation of the present invention; the identification process can also be performed automatically. If the identification process is successful, according to the embodiment of the present invention, the controlling circuit 1012 generates a first control signal S₁′ which signals the first communication interface 1013 to receive the data S_{data} from the electronic apparatus 102 (step 206). The data S_{data} is then transmitted from the communication device 1022 of electronic apparatus 102, and the data S_{data} from the electronic apparatus 102 can be stored into the memory device 1015.

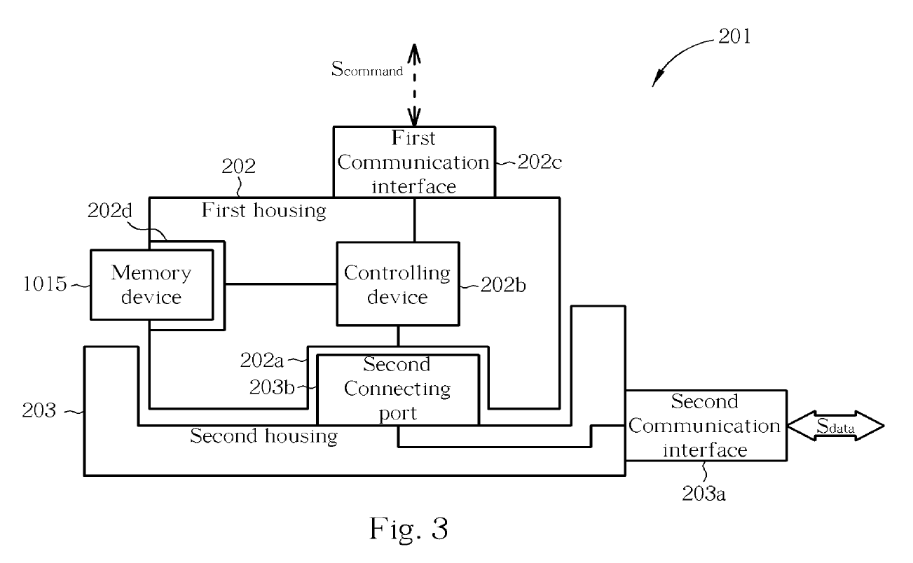

Please refer to FIG. 3. FIG. 3 is a diagram illustrating another embodiment of a remote controller 201 according to the present invention. The remote controller 201 comprises a first housing 202 and a second housing 203. The first housing 202 is utilized for holding a first connecting port 202a, a controlling circuit 202b, a first communication interface 202c, and a memory interface 202d, wherein the first connecting port 202a is coupled to the controlling circuit 202b. The second housing 203 is utilized for holding the second communication interface 203a, and a second connecting port 203b that is coupled to the second communication interface 203a, wherein the second connecting port 203b is detachably coupled to the first connecting port 202a. Similar to the remote controller 101, the remote controller 201 is also utilized for controlling the electronic apparatus 102. Furthermore, the configuration of the remote controller 201 is almost the same as the remote controller 101: the only difference is the second housing 203. Therefore, the following paragraph is focused on the description of the second housing 203.

When the second connecting port 203b is coupled to the first connecting port 202a and the memory device 1015 is coupled to the memory interface 202d, the data in the memory device 1015 can be transmitted to the electronic apparatus 102 through the second communication interface 203a. In other words, after the identification process between the remote controller 201 and the electronic apparatus 102 is accomplished via the first communication interface 202c, the controlling circuit 202b can activate the first connecting port 202a to transmit the data from the memory device 1015b to the second connecting port 203b. Then, the second connecting port 203b transmits the data to the second communication interface 203a for transmission. According to the embodiment of the present invention, the second communication interface 203a is a Bluetooth interface, the first communication interface 202c is an infrared (IR) interface, and the memory interface 202d is a card reader for detachably coupling to the memory device 1015. However, this is not meant to be a limitation of the present invention.

Those skilled in the art will readily observe that numerous modifications and alterations of the device and method may be made while retaining the teachings of the invention.

What is claimed is:

1. A remote controller of an electronic apparatus, comprising:
a memory interface, for communicating with a memory device;
a controlling circuit, coupled to the memory interface, for generating a first control signal; and
a first communication interface, coupled to the controlling circuit, for communicating with the electronic apparatus to transfer data between the memory device and the electronic apparatus according to the first control signal.

2. The remote controller of claim 1, wherein the first communication interface is an infrared (IR) interface.

3. The remote controller of claim 1, wherein the first communication interface is a Bluetooth interface.

4. The remote controller of claim 1, wherein the memory interface is a card reader for detachably coupling the memory device.

5. The remote controller of claim 1, wherein the controlling circuit further generates a second control signal, and the remote controller further comprises:
a second communication interface, coupled to the controlling circuit, for communicating with the electronic apparatus to transfer commands associated with access of the memory device from the controlling circuit to the electronic apparatus according to the second control signal.

6. The remote controller of claim 5, wherein a data transfer rate of the first communication interface is higher than a data transfer rate of the second communication interface.

7. The remote controller of claim 6, wherein the first communication interface is a Bluetooth interface, and the second communication interface is an infrared (IR) interface.

8. The remote controller of claim 5, further comprising:
a first housing, for holding a first connecting port, the controlling circuit, and the first communication interface, wherein the first connecting port is coupled to the controlling circuit; and
a second housing, for holding the second communication interface and a second connecting port coupled to the second communication interface, wherein the second connecting port is detachably coupled to the first connecting port.

9. The remote controller of claim 5, wherein the memory interface is a card reader for detachably coupling the memory device, the second communication interface is an infrared (IR) interface, and the memory device stores IR control codes.

10. A remote control method of an electronic apparatus, comprising:
communicating with the electronic apparatus to transfer a first command associated with access of a memory device to the electronic apparatus;
receiving a second command outputted from the electronic apparatus in response to the first command; and
communicating with the electronic apparatus to transfer data between the memory device and the electronic apparatus according to the second command.
